(19) United States
(12) Patent Application Publication
(10) Pub. No.: US 2006/0065493 A1
(43) Pub. Date: Mar. 30, 2006

(54) Hand railing with mounting for receiving panels

(76) Inventor: Glenn H. Bostock, Bryn Athyn, PA (US)

Correspondence Address: SYNNESTVEDT & LECHNER, LLP, 2600 ARAMARK TOWER, 1101 MARKET STREET, PHILADELPHIA, PA, 191072950, US

(21) Appl. No.: 11/236,078

(22) Filed: Sep. 27, 2005

Related U.S. Application Data
(60) Provisional application No. 60/614,930, filed on Sep. 30, 2004.

(51) Int. Cl. B66B 7/02

(52) U.S. Cl. 187/406

(57) ABSTRACT

A railing adapted to support a panel is disclosed. The railing is mountable on a support structure and has an elongated hand grip attached to a mounting piece. The mounting piece is adapted for attachment to the support structure. A support surface is positioned on the mounting piece. The support surface is adapted to engage and support the panel. An assembly including the hand rail and a panel having a support surface engaging the support surface of the hand rail and supported thereby is also disclosed. A method of assembling a panel onto a support structure is disclosed including attaching the mounting piece to the structure, engaging the support surfaces of the mounting piece and panel with one another, and attaching the panel to the support structure.

### FIELD OF THE INVENTION

This invention concerns a railing that forms a mounting structure for mounting panels on a support structure.

### BACKGROUND OF THE INVENTION

In the construction of elevators, it is advantageous to provide an interior that is architecturally pleasing. This is often accomplished by mounting decorative panels onto the elevator cab or cage. The panels may display rich wood grain, mirrored surfaces, brushed steel or decorative embossments or moldings and serve to hide the functional appearance of the elevator cab. A hand rail is also often provided for convenience of the elevator's occupants.

Decorative panels may be heavy and, therefore, require robust attachment to the supporting structure provided by the elevator cab. Because the elevator cab is not a static structure, the panels are subjected to inertial loads when the cab is accelerated during starting and stopping. Particularly high forces are induced during testing of the elevator, when interior panels have been known to break free of their mountings and fall into the interior of the elevator cab.

Mounting of the panels is a challenge because the mounting must be robust while not compromising the decorative aspects of the elevator's interior design. It is also preferable to mount the panels from the interior of the cab because there is limited space between the cab and the elevator shaft which makes access to the mounting hardware difficult. The cab interior should also be proof against vandalism so that it is difficult to remove interior elements.

In view of the history and potential for elevator panel failure, as well as the desired characteristics of ease of assembly and resistance to vandalism, there is clearly a need for a design that better fulfills all of the requirements of structural integrity and architectural acceptance while incorporating all of the interior components in an integrated design.

### SUMMARY OF THE INVENTION

The invention concerns a hand railing adapted to support a panel. The railing is mountable on a support structure and comprises an elongated hand grip. The grip is attached in spaced apart relation to a mounting piece adapted for attachment to the support structure. Preferably, the mounting piece comprises an elongated plate. A support surface is positioned in spaced relation to the hand grip. The support surface is preferably positioned on an edge of the mounting piece and is adapted to engage and support the panel.

The invention further includes an assembly mountable on a support structure. The assembly comprises an elongated hand grip and a mounting piece adapted for attachment to the support structure. The hand grip is attached to the mounting piece. A first support surface is positioned is positioned in spaced relation to the hand grip and preferably on the mounting piece. A panel has a second support surface engaged with the first support surface for mounting the panel onto the support structure.

The invention further includes a method of assembling a panel onto a support structure. The method comprises:
(A) attaching a mounting piece to the support structure, a hand grip being attached to the mounting piece, a first support surface being positioned on the mounting piece;
(B) providing a panel having a second support surface engageable with the first support surface;
(C) engaging the first and second support surfaces with one another; and
(D) attaching the panel to the support structure.

### BRIEF DESCRIPTION OF THE DRAWINGS

FIG. 1 is a perspective view of an assembly of panels and railings according to the invention mounted on a support structure comprising an elevator cab;

FIG. 2 is a cross-sectional view taken at circle 2 in FIG. 1 showing details of the invention; and

FIG. 3 is a cross-sectional view illustrating an alternate embodiment of the invention.

### DETAILED DESCRIPTION OF THE PREFERRED EMBODIMENTS

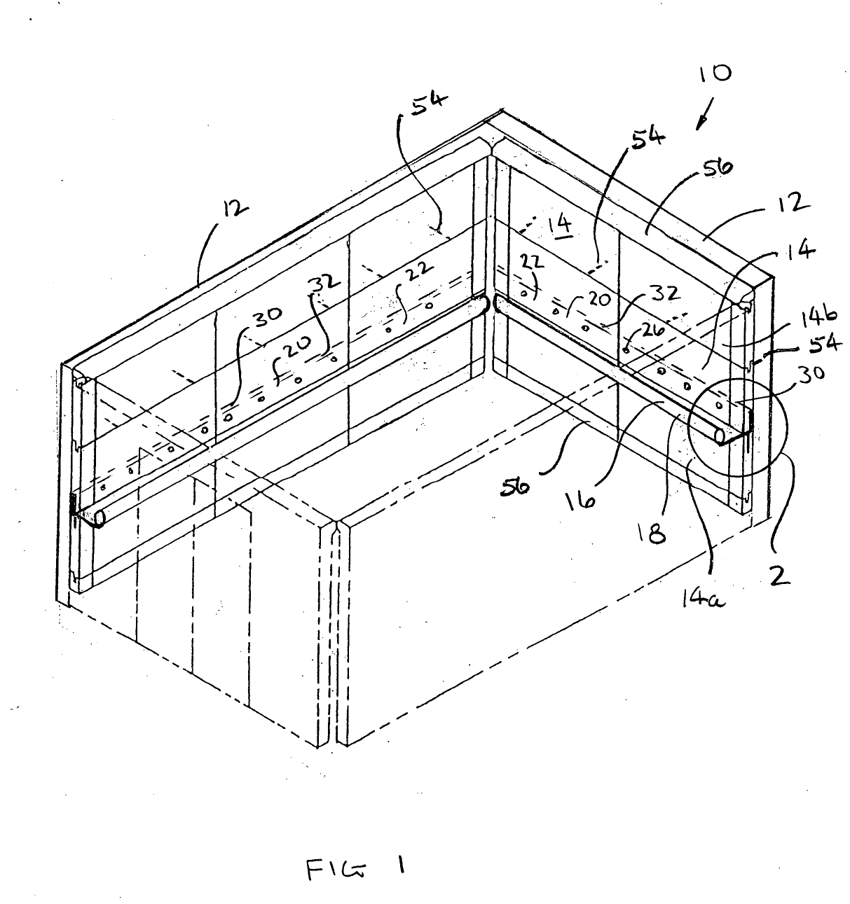

FIG. 1 shows an elevator 10 having a cab or cage 12 to which are attached panels 14 and a hand railing 16 according to the invention. The elevator cab 12 provides a support structure on which the panels 14 and railing 16 are mounted, it being understood that the use of an elevator cab to provide a support structure is by way of example only. The invention is not confined for use with an elevator but may be used on virtually any structure to which panels are to be mounted.

The panels 14 provide a decorative interior surface to the elevator 10 and may be formed from wood, metal, plastic as well as other materials that provide a finished look that hides the functional features of the elevator. The hand rail 16 is also decorative but additionally serves as a safety feature, allowing occupants a convenient purchase for steadying themselves during transit.

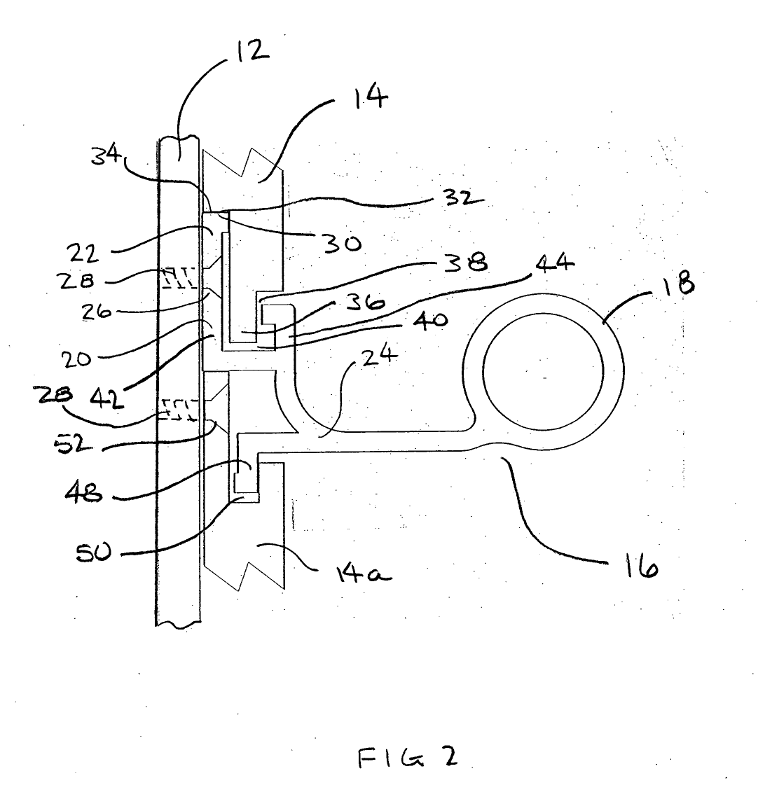

The railing additionally serves in a structural capacity to mount the panels 14 to the cab 12 as shown in FIG. 2. Hand railing 16 comprises an elongated hand grip 18 that extends along the elevator's interior in spaced relation away from the panels 14. Hand grip 18 is shown with a round cross section, but may have other cross-sectional shapes that afford easy and sure manual gripping. The grip 18 is preferably continuous along an interior wall of the elevator 10, but could also be divided into individual sections, or a plurality of shorter segments.

Hand grip 18 is attached to a mounting piece 20 that is adapted to attach to the elevator cab 12 or other support structure. Preferably, mounting piece 20 comprises an elongated plate 22 that extends along the support structure in substantially parallel relationship to the elongated grip 18. Grip 18 is attached to plate 22 through intervening structure 24 that maintains the two components in spaced relation to each other. Preferably, the grip 18, plate 22 and intervening structure 24 are formed from a continuous extrusion in stock lengths that may be cut to a desired length as required for a particular application.

As shown in FIGS. 1 and 2, plate 22 has a plurality of holes 26 positioned in lengthwise spaced relation. The holes 26 receive fasteners, such as screws 28 that attach the plate to the support structure, elevator cab 12. Preferably, the top edge 30 of plate 22 has a support surface 32 that engages a surface 34 formed on the panels 14. Surface 34 is preferably positioned parallel and in spaced relation to an edge 36 of the panel 14. Panel edge 36 preferably extends past the holes 26 and is received within an opening 38 defined by a channel 40. Channel 40 is formed by a pair of sidewalls 42 and 44 positioned in spaced apart relation from each other. Preferably, one of the sidewalls 42 comprises the plate 22. By extending the edge 36 of panel 14 past the holes 26 and into channel 40, a finished appearance is provided that hides functional elements of the structure, such as the holes 26 and fasteners 28. This feature provides enhanced resistance to vandalism as the fasteners are hidden from view and access to them is difficult. Preferably, the outwardly facing sidewall 44 is narrower than the opposing sidewall 42. This prevents contact between the sidewall 44 and the panel, for reasons described below.

It is preferred that the panel edge 36 not contact any portion of the channel 40 to ensure that any loads caused by the weight of panels 14 or inertial forces on the panels are transmitted only through the support surface 32, into the plate 22 and through the fasteners 28, loading them primarily in shear. This load path reduces the moment loads at the railing-support structure interface and provides a robust structural joint that can withstand high loads. This is important for moving structures, such as elevators, in which components, such as the panels 14, may experience high inertial forces during emergency stops or during testing, when the elevator is halted abruptly. If not securely fastened to the support structure, the panels 14 and the railing 16 may break away from the cab 12 and collapse into the interior of the elevator 10. Greater safety is achieved by engaging the panels 14 with the plate 22 at the support surface 32 thereby reducing the applied moment loads to the joint between the railing 16 and the cab 12 or other support structure.

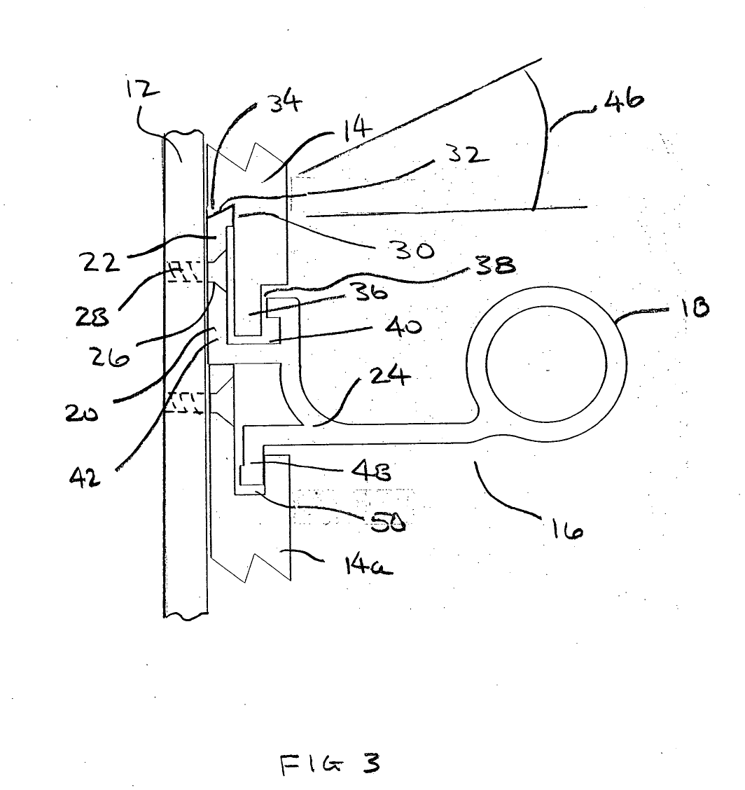

In an alternate embodiment, illustrated in FIG. 3, the support surface 32 is angularly oriented relatively to the plate 22. Preferably, the surface angle 46 slopes away from the grip 18 and toward the support structure 12. The surface 34 on the panel 14 that engages the support surface 32 is also angularly oriented, but at a complementary angle to the angle 46. By angling the interfacing surfaces 32 and 34, the panel 14 tends to be forced against the support structure 12 by its own weight, thus, increasing the structural integrity of the joint between the panels 14, railing 16 and the cab 12.

As shown in FIG. 2, a tongue 48 is attached to the railing 16 substantially aligned with channel 40. Tongue 48 extends in a direction substantially opposite to the opening 38 and engages a groove 50 positioned within a panel 14a positioned beneath panel 14 (see also FIG. 1). Panel 14a is attached to the support structure 12 by a fastener 28, and the tongue 48 is captured within the groove 50 to prevent the railing 16 from bending away from the support structure 12. Together with the intervening structure 24 of the railing 16, the tongue 48 helps to cover openings 52 in panel 14a and fasteners 28 attaching the panel to the support structure, thereby providing a finished appearance.

Assembly of the panels 14 and railing 16 to a support structure such as elevator cab 12 may be described with reference to FIGS. 1 and 2. As shown in FIG. 1, the panel 14a is attached directly to the cab 12 by a plurality of fasteners 28 extending through holes 52. Next, as shown in FIG. 2, the tongue 48 of railing 16 is positioned within groove 50, plate 22 is engaged with the cab 12, and fasteners 28 are engaged with holes 26 to secure the plate to the cab. Next the panel 14 is positioned with its edge portion 36 within channel 40, the panel surface 34 engaging support surface 32 along the top edge 30 of plate 22. As shown in FIG. 1, the panel 14 is then attached to cab 12 using fasteners 54 positioned along the panel's top edge. Additional panels 14b are attached to the cab 12 above the panels 14 supported by the railing, all of the panels 14b engaging panels 14 using a tongue and groove arrangement as disclosed in U.S. application Ser. No. 09/490,268, hereby incorporated by reference. Decorative moldings 56 may be used at the top and bottom of the panels to complete the interior.

What is claimed is:

1. A railing graspable by a hand and adapted to support a panel, said railing being mountable on a support structure, said railing comprising:
an elongated hand grip;
a mounting piece adapted for attachment to said support structure, said hand grip being attached to said mounting piece in spaced apart relation therefrom; and
a support surface positioned in spaced relation to said hand grip, said support surface being adapted to engage and support said panel.

2. A railing according to claim 1, wherein said mounting piece comprises an elongated plate extending substantially parallel to said hand grip.

3. A railing according to claim 2, wherein said support surface is positioned along an edge of said plate.

4. A railing according to claim 3, wherein said support surface is angularly oriented with respect to said plate, said support surface sloping away from said hand grip.

5. A railing according to claim 2, wherein said elongated plate has a plurality of holes positioned in spaced apart relation lengthwise therealong, said holes for receiving fasteners for attaching said plate to said support structure.

6. A railing according to claim 1, further comprising a channel positioned between said mounting piece and said hand grip, said channel defining an opening sized to receive an edge portion of said panel.

7. A railing according to claim 6, wherein said channel is defined by first and second sidewalls positioned in substantially parallel, spaced apart relation to one another.

8. A railing according to claim 7, wherein said support plate comprises said first sidewall.

9. A railing according to claim 8, wherein said first sidewall is wider than said second sidewall.

10. A railing according to claim 6, further comprising a tongue positioned substantially in alignment with said channel, said tongue projecting in a direction substantially opposite to said opening for engagement with an edge portion of another said panel.

11. An assembly mountable on a support structure, said assembly comprising:
an elongated hand grip adapted for manual grasping;
a mounting piece adapted for attachment to said support structure, said hand grip being attached to said mounting piece in spaced apart relation therefrom;
a first support surface positioned in spaced relation to said hand grip; and
a panel having a second support surface engaged with said first support surface for mounting said panel onto said support structure.

12. An assembly according to claim 11, wherein said mounting piece comprises an elongated plate extending substantially parallel to said hand grip.

13. An assembly according to claim 12, wherein said first support surface is positioned along an edge of said plate.

14. An assembly according to claim 13, wherein said first support surface is angularly oriented with respect to said plate, said first support surface sloping away from said hand grip, and wherein said second support surface is angularly oriented at a complementary angle to said first support surface.

15. An assembly according to claim 12, wherein said elongated plate has a plurality of holes positioned in spaced apart relation lengthwise therealong, said holes for receiving fasteners for attaching said plate to said support structure.

16. An assembly according to claim 13, further comprising a channel positioned between said plate and said hand grip, said channel defining an opening sized to receive an edge portion of said panel.

17. An assembly according to claim 16, wherein said channel is defined by first and second sidewalls positioned in substantially parallel, spaced apart relation to one another, said first sidewall being comprised of said plate.

18. An assembly according to claim 17, wherein said second support surface is positioned along said panel in spaced relation from said edge portion, said first support surface engaging said second support surface and said edge portion being positioned within said channel.

19. An assembly according to claim 11, further comprising:
a tongue attached to said hand grip and projecting in a direction substantially opposite to said opening defined by said channel; and
a second panel having an edge with a groove therein sized to receive said tongue, said second panel being mountable on said support structure with said tongue engaged within said groove.

20. An assembly according to claim 16, wherein said edge portion of said panel extends into said channel and overlaps said elongated plate.

21. A method of assembling a panel onto a support structure, said method comprising:
attaching a mounting piece to said support structure, a hand grip being attached to said mounting piece, a first support surface being positioned on said mounting piece;
providing a panel having a second support surface engageable with said first support surface;
engaging said first and second support surfaces with one another; and
attaching said panel to said support structure.
